(19) United States
(12) Patent Application Publication
(10) Pub. No.: US 2025/0079864 A1
(43) Pub. Date: Mar. 6, 2025

(54) Method and Apparatus of a Portable Segmented Power Unit

(71) Applicant: Creative Systems and Design LLC, Baltimore, MD (US)

(72) Inventors: Muniswamappa Anjanappa, Ellicott City, MD (US); Stephen Argo, Ellicott City, MD (US)

(21) Appl. No.: 18/823,092

(22) Filed: Sep. 3, 2024

Related U.S. Application Data
(60) Provisional application No. 63/536,188, filed on Sep. 1, 2023.

(51) Int. Cl. H02J 7/00

(52) U.S. Cl. CPC H02J 7/0063; H02J 7/0042; H02J 2310/12

(57) ABSTRACT

A portable segmented power device (PSP) device having multiple compact interconnected, removable, and independently operable rechargeable battery powered modules, allowing for a user to simultaneously and independently provided power to devices situated at two or more different locations by slipping out one or more compact modular units from the device and carry each compact modular unit to a respective location for safe, convenient, and independent operation.

### BACKGROUND OF THE INVENTION

Although there are many battery powered backup systems, they are limited to use in one physical location. Such systems are not suitable if the physical storage unit is required at multiple physical locations. For example, consider a typical residential application where a standard residential battery powered backup system is used to supply power to a living room, kitchen, bedroom, and den simultaneously. While it is indeed possible (and common) to run extension cables to those different locations, that solution is neither safe nor convenient.

### SUMMARY OF THE INVENTION

The present invention overcomes the disadvantages of the prior art by providing a portable segmented power device (PSP) device, i.e., a battery powered device having multiple compact interconnected, removable, and independently operable modules, allowing for a user to simultaneously and independently power two or more different locations by slipping out one or more compact modular units from the device and carry each compact modular unit to a respective location for safe, convenient, and independent operation.

Therefore, there is provided according to the invention a portable segmented power device including, a base unit and a plurality of secondary modules, the base unit including a rechargeable base unit battery pack, one or more base unit power charging ports configured for connection to a power source for recharging the rechargeable battery pack, one or more base unit power discharging ports configured for providing power to external devices, a base unit battery management system configured for managing and monitoring battery charging and discharging operations and optionally for recognizing missing modules, a base unit user input/selection device in electronic communication with the base unit battery management system, a base unit display device in electronic communication with the base unit battery management system and the base unit user input/selection device. Each one of the plurality of secondary modules include one or more secondary module power charging ports configured for connection to a power source for recharging the secondary module rechargeable battery packs, one or more secondary module power discharging ports configured for providing power to external devices, a secondary module battery management system configured for managing and monitoring battery charging and discharging operations, a secondary module user input/selection device in electronic communication with the secondary module battery management system, a secondary module display in electronic communication with the secondary module battery management system and the secondary module user input/selection device, and an inter-unit power connection configured for electrical connection and delivering power to and receiving power from the base unit and/or an adjacent one or more of the plurality of secondary modules. The base unit also includes one or more secondary module connections configured for electrical connection and delivering power to and receiving power from one or more of the plurality of secondary modules.

### BRIEF DESCRIPTION OF DRAWINGS

FIG. 1 is a front perspective view of a base unit of a portable segmented power device according to an embodiment of the invention.

FIG. 2 is a block diagram of a base unit battery management system for a portable segmented power device according to an embodiment of the invention.

FIG. 3 is a block diagram of a subsidiary unit battery management system for a portable segmented power device according to an embodiment of the invention.

Features in the attached drawings are numbered with the following reference numerals:
1 Base Unit
2 Charging Ports
3 Base Unit Display
4 Rotate/Select Knob
5 Discharge Ports
6 Segment Module-1
7 Display
8 Rotate/Select Knob
9 Discharge Ports
10 Segment Module-2
11 Segment Module-3

### DETAILED DESCRIPTION OF THE INVENTION

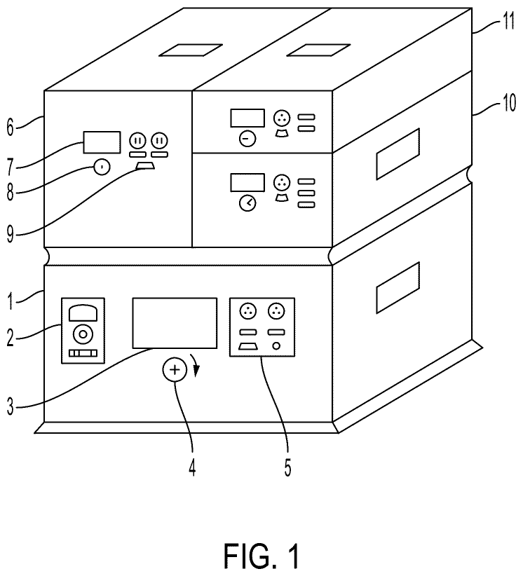

Referring to FIG. 1, a non-limiting exemplary preferred embodiment of a portable segmented power device according to the invention is described. Base unit 1 is connected directly or indirectly to at least one and preferably two or more subsidiary segment modules 6, 10 and 11. The segment modules may be directly connectable to base unit 1 (see, e.g., FIG. 1, segment modules 6 and 10), or indirectly connectable to base unit 1 through another segment module (see, e.g., FIG. 1, segment module 11, connectable to base unit 1 through segment module 10). According to a preferred embodiment, the connections between segment modules to one-another and to the base unit may be the same, so that segment modules may be connected to the base unit 1 in multiple different configurations. As one example, a user may remove segment modules 10 and 11 for simultaneous use in different locations away from the base unit 1, and, after a time, segment module 11 may be returned and reconnected directly to base module 1 or to segment module 6 before segment module 10 is returned and reconnected. Details of the connections between segment modules and base unit 1 is described in more detail below.

According to a first embodiment, all charging of the PSP device of the invention takes place in/through base unit 1. According to this embodiment, all segment modules are charged through the base unit. The base unit 1 may have one or more charging ports 2 adaptable for A/C and/or 12Volt DC power supply. In addition, the base unit may have an integrated solar panel or may be outfitted for connection to a solar panel power output.

According to an alternate embodiment, in addition to charging of the segment modules through the base unit, one or more segment modules 6, 10, 11 may be charged directly. In such case, one or more segment modules may have one or more charging ports as described above.

According to various embodiments, the base unit and each segment module may contain one or more rechargeable batteries. According to a preferred embodiment, the batteries may be Lithium-Iron-Phosphate (LiFePo) batteries, although any other type of rechargeable battery may be used, including but not limited to, Lithium-Ion (Li), Sodium-ion (Nai), and Hydrogen batteries.

The size and power output of the base unit and each segment module may be selected according to manufacturer preference and user demand. For example, a 3,600 watt-hour PSP device according to the invention may have (i) a base unit with a 50% power capacity, and (ii) three separable segmented modules with power capacity of 25%, 15%, and 10% respectively.

In such case, a PSP having such configuration and power distribution might be constructed as follows:
one 1,800 Watt hour base unit having ninety (90) LiFePo 18650 cylindrical batteries, (each battery: 18 mm diameter and 65 mm long),
one 900 Watt hour segment module having forty five (45) LiFePo 18650 cylindrical batteries,
one 540 Watt hour segment module having twenty seven (27) LiFePo 18650 cylindrical batteries, and
one 360 Watt hour segment module having eighteen (18) LiFePo 18650 cylindrical batteries.
   Of course, it should be understood that a PSP according to the invention may be constructed according to any combination of base unit and segment modules with base unit and segment modules having any variation of numbers, sizes, and power distributions, battery sizes and technologies and stacking configuration. Indeed, segment modules may include small and very small units of the type suitable for short-term charging of mobile devices.

Discharging of the PSP device according to the invention (provision of power as needed) may take place through the base unit alone, through the base unit with any number of connected segment modules, through a single segment module alone and separated from the base, or through any combination of any interconnected segment modules separated from the base unit. Base unit preferably has multiple discharge ports 5, including but not limited to 110/230-volt A/C sockets and various USB ports, including USB-A, USB-B, USB-C, Lightning, Micro-USB, Mini-USB and/or Aux. Each segment module has at least one and preferably multiple discharge ports 9.

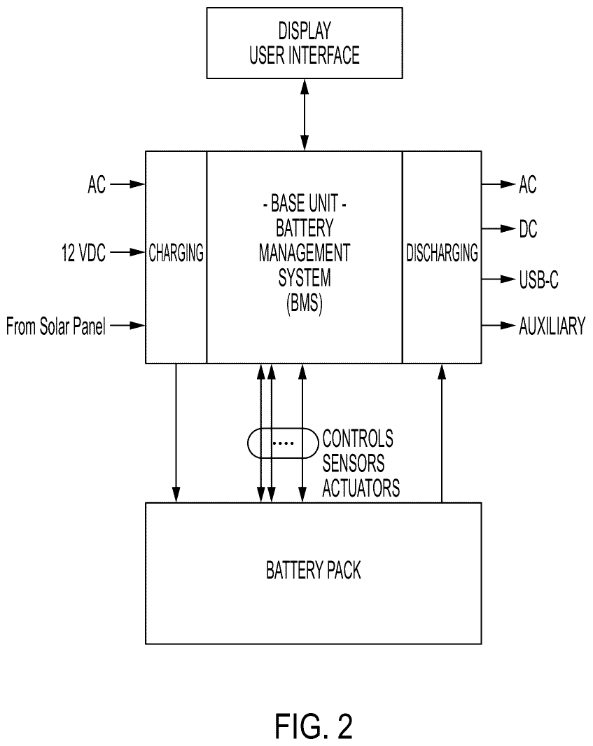

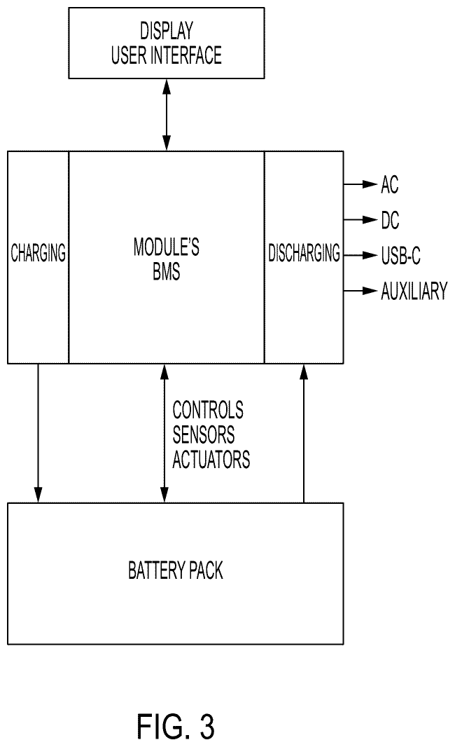

Power charging and discharging of the PSP according to the invention is controlled via base unit master battery management system (BMS) controller (see FIG. 2), and the slave BMS control systems in the segment modules (see FIG. 3). Users may select power charging and/or discharging preferences using base unit rotate/select knob 4 and/or segment modules rotate/select knob 8. The master and slave BMS systems each include various control, sensor and actuator devices to manage and monitor power flow to and out of the battery packs during use (charge and discharge). BMS systems also monitor charge level during inactivity. User selections, battery charge level and other features may be displayed on base unit display 3 and/or segment module displays 7.

The base unit may be electrically connected to adjacent segment modules by any conventional power connection that permits bi-directional power flow for charging of the segment module battery packs and for providing power through the base module when it is connected to one or more segment modules. Examples include but are not limited to 110/230-volt A/C sockets and various USB ports, including USB-A, USB-B, USB-C, Lightning, Micro-USB, Mini-USB and/or Aux. Similarly, segment modules may be electrically connected to adjacent segment modules in the same way.

According to an optional feature, each segment module may be connected to another segment module and/or to the base unit 1 by an additional mechanical device to mitigate or avoid strain on the electrical connections between base unit/segment module/segment module.

It will be appreciated by those skilled in the art that changes could be made to the preferred embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification. In particular, it should be understood that every element and feature disclosed herein, no matter how disclosed, may be used in every combination and sub-combination with every other element and feature disclosed herein. Stated another way, every combination and sub-combination of every element and feature disclosed herein is considered by the inventors to be an invention hereunder and disclosed herein by this statement.

1. A portable segmented power device comprising:
a. A base unit, and
b. A plurality of secondary modules,
said base unit comprising:
i. a rechargeable base unit battery pack,
ii. one or more base unit power charging ports configured for connection to a power source for recharging said rechargeable battery pack,
iii. one or more base unit power discharging ports configured for providing power to external devices,
iv. a base unit battery management system configured for managing and monitoring battery charging and discharging operations and optionally for recognizing missing modules,
v. a base unit user input/selection device in electronic communication with said base unit battery management system,
vi. a base unit display device in electronic communication with said base unit battery management system and said base unit user input/selection device,
each one of said plurality of secondary modules comprising:
vii. one or more secondary module power charging ports configured for connection to a power source for recharging said rechargeable battery pack,
viii. one or more secondary module power discharging ports configured for providing power to external devices,
ix. a secondary module battery management system configured for managing and monitoring battery charging and discharging operations,
x. a secondary module user input/selection device in electronic communication with said secondary module battery management system,
xi. a secondary module display in electronic communication with said secondary module battery management system and said secondary module user input/selection device,
xii. an inter-unit power connection configured for electrical connection and delivering power to and receiving power from said base unit and/or an adjacent one or more of said plurality of secondary modules,
said base unit comprising one or more secondary module connections configured for electrical connection and delivering power to and receiving power from one or more of said plurality of secondary modules.
